(19) United States
(12) Patent Application Publication
(10) Pub. No.: US 2024/0369501 A1
(43) Pub. Date: Nov. 7, 2024

(54) FEEDING DEVICE FOR AN X-RAY INSPECTION DEVICE

(71) Applicant: WIPOTEC GMBH, Kaiserslautern (DE)

(72) Inventors: Sebastian MORSCH, Wiebelskirchen (DE); Christian KUCKELBERG, Blieskastel (DE); Michael SIEGRIST, Kaiserslautern (DE); Bernd ZINKE, Mandelbachtal (DE); Michael BAULE, Giesen (DE)

(21) Appl. No.: 18/654,101

(22) Filed: May 3, 2024

(30) Foreign Application Priority Data
May 4, 2023 (DE) 102023111658.4

(51) Int. Cl. G01N 23/083

(52) U.S. Cl. CPC G01N 23/083; G01N 2223/643

(57) ABSTRACT

The invention relates to a hygienic modular feed device for an inspection device, in particular an X-ray inspection device, for transferring products of a product stream consisting of bulk material, which is supplied from a substantially vertical z direction into a substantially horizontal conveying direction x and thus onto a conveying plane located in the x-y direction perpendicular to the z direction, wherein the feed device has an inlet opening above, as viewed in the z direction, oriented substantially in the z direction, and an outlet opening below, as viewed in the z direction, oriented substantially in the x direction, both openings being connected to an intermediate region, the intermediate region having a curved wall on the rear side, as viewed at least in the conveying direction x, to gently change the direction of the products from the z direction into the x direction, such that the pressure generated by the falling movement of the products is at least partially absorbed by the wall, and accordingly the pressure of the product stream on a conveyor system, in particular conveyor belt, arranged below the outlet opening is reduced. The invention also relates to a method for optimizing inspection outcomes using such an inspection device.

The invention relates to a feed device for an inspection device, in particular an X-ray inspection system, and to a method therefor.

Such inspection devices and methods are used for bulk materials, especially in the food sector (e.g., rice, coffee beans), to inspect them for possible foreign bodies. For this purpose, a product stream is guided through an inspection device, in particular an X-ray inspection device, by means of a conveyor system, in particular a conveyor belt. The product is supplied via a hose from above.

The large drop height of the conveyed material (several meters) causes a number of problems. This means that products can break—although only whole products, such as coffee beans, are desirable. In addition, products can jump past the conveyor system, especially the belt, and/or over lateral guides (lateral guides) and make inspection more difficult.

Furthermore, a high level of dust development can impair the inspection and contaminate or even damage the inspection device and the conveyor system. The formation of ignitable dust/air mixtures must be avoided at all costs; and blowing compressed air in particular is not permitted (dust formation).

An irregular product stream height across the belt width makes inspection more difficult, especially X-ray evaluation.

The considerable back pressure from above makes belt start-up more difficult and requires an increased motor current and/or a larger drive motor.

With conventionally operated inspection devices, it is difficult to access the supply hopper and thus dismantle it for cleaning. In addition, machine failure often occurs with small-grained bulk material (due to jamming under the lateral guide, uncontrolled jumping, etc.).

The present invention is therefore based on the task of creating a feed device for an inspection device, as well as an inspection device having such a feed device, and a method for optimizing the inspection outcomes of an inspection device having such a feed device, which avoids the above disadvantages and effects a gentle change of direction of the products of a product stream consisting of bulk material from the z direction to the x direction.

According to the invention, this task is solved by a feed device having the features of claim 1, by an inspection device having the features of claim 9, and by a method having the features of claim 14.

The feed device according to the invention has an intermediate region which is designed as a curved wall at the rear, as viewed in the conveying direction x. The curvature of the wall occurs in profile (x-z plane) along a curve that transitions from a substantially vertical (z axis) orientation to an almost horizontal orientation (x axis). The wall preferably ends before the horizontal is reached, so that an angle greater than zero is formed with the x axis.

For the purposes of the invention, the curvature can occur along any curve shape, and the term curvature also includes a curve with a straight portion or multiple straight portions with discontinuous transitions. Preferably, at least the rear wall has no corners or edges, so that the risk of damage to the products, in particular unpackaged foodstuffs such as nuts, peas, corn or rice, can be reduced.

For the purposes of the invention, the products are products of a product stream consisting of bulk material, even though the term “products” is used in the following. Individual or discrete products, such as bottles, cups, closures, tablets, etc., which are present individually or are separated during processing, are therefore not to be understood as products of a product stream consisting of bulk materials.

In any case, this wall causes a gentle change of direction of the products from the z direction to the (almost) x direction. The pressure (of the vertically falling products) is at least partially absorbed by the wall, so that the pressure (resulting from the weight force and/or the kinetic energy) of the product stream (column) is reduced on a conveyor system, in particular a conveyor belt, arranged below the outlet opening (static pressure when the belt is stationary and dynamic pressure during operation). Advantageously, this can reduce the stress on the conveyor system. In particular, the belt start-up is facilitated so that no increased motor current and/or larger drive motor is required. The operation of the inspection device preferably comprises not only the inspection itself but also other possible operating modes, such as maintenance mode, cleaning mode, etc.

The feed device is made of hygienic, easy-to-clean material, preferably stainless steel, so that it is safe to use in the food sector. The feed device is preferably designed as a module so that it can be quickly and easily removed from and inserted into an inspection device or inspection device, even if the feed devices are of different designs. This makes it possible to respond to different requirements, especially when the product is changed, requiring screens, impact elements, etc. to be replaced.

In a preferred embodiment of the invention, the curved rear wall ends in the direction of the outlet opening before it merges into the horizontal, so that each region of the curvature has an angle greater than zero tangential to the horizontal x axis. This prevents products from remaining in the feeder or even clogging it.

In its end region, the intermediate region can end before reaching the outlet opening, so that there is a gap between the lower end of the intermediate region and the outlet opening, and any adjusting element, as viewed in the x direction.

In a further embodiment of the invention, the intermediate region has a downwardly bending lower edge in its end region before the outlet opening. This allows reliable emptying after the product feed has been completed. Preferably, the lower edge extends close to the top of the conveyor plane so that the lower edge empties the conveyor plane, in particular the belt, before the product stream is applied.

In a particularly preferred embodiment of the invention, the feed device has an adjusting element on the outlet side and/or at the outlet opening, for example in the form of a preferably flat adjusting plate or an adjusting flap, which can be adjusted substantially in its height in the z direction. This adjusting element makes it easy to set the height of the outlet opening (variably). Preferably, there is a clear distance between the adjusting element and the end of the bent lower edge.

In a further embodiment of the invention, the adjusting element is adjustable in its inclination with respect to the vertical z axis. An appropriate setting enables adjustment to the flowability properties of the respective products.

The adjusting element and its corresponding setting (vertical and/or with inclination) can also be used to limit the product stream height and/or the thickness of the product stream deposition to a desired degree, so that less energy is sufficient for the irradiation- and, in particular, the power of an X-ray source can be reduced.

Since the transmission and thus the gray values of the inspection image of a product stream depend on its mass per volume and/or its density, i.e., bulk density, it is also advantageous to select the product stream height as a function of the product stream density and/or bulk density so that the mass flow can be kept constant at a prespecified level. For example, with a higher bulk density, a lower product stream height is set, so that no increase in radiation energy is required.

It is also conceivable to ensure a constant single-layer product stream. In this way, a purely visual inspection can also be carried out to the highest quality, as the concealment of invisible layers of bulk material underneath is avoided.

Adjustment in the z direction and/or setting the inclination can be done manually or automatically (preferably with a display of the currently set height). It is also conceivable to save and archive the settings made, in particular as proof of production (in a corresponding storage device).

In a further embodiment of the invention, the feed device has a control device that enables adapting the height and/or the angle of inclination of the adjusting element to the conveying speed of the conveyor system during operation of the inspection device. The adjusting element is adapted, for example, by means of controllable actuators, servomotors or similar.

In this way, a constant product stream height can be generated as continuously as possible, especially in the x direction- and thus a constant conveyed product volume. However, a variable height can also be provided in the y direction. For example, it is conceivable that the product stream height decreases towards the side edges in order to make optimum use of the radiographic width of the X-ray inspection device, and the transport width or belt width of the conveyor system.

In a further embodiment of the invention, the adjusting element has a curved lower edge so that the product stream height in the y direction can be adapted to a passage path of the X-rays through the bulk material, and the passage path is preferably almost the same length at any angle. Accordingly, X-rays propagating in a fan shape from an X-ray source in the y direction can be used without changing the gray values of the inspection image of a homogeneous product stream towards the edges-due to higher absorption caused by the longer transmission path. In particular, the lower edge can be symmetrical to the x-z plane in relation to a centrally raised region, and have flanks that continuously increase laterally towards the bottom.

In a particular embodiment of the invention, the feed device has a connection piece in the area of the inlet opening, in particular a multi-step connection piece with different, predefined connection widths. In this way, one and the same feed device can be used in different inspection devices with different, usually standardized connection widths. Preferably, mechanical decoupling can be achieved through the connection piece, for example by means of a flexible connection or by providing clearance. The connection piece can therefore also serve as protection against vibrations caused by a vibrating pipe, for example. It is also conceivable that the connection piece acts as dust protection and prevents dust from escaping to the outside.

In a further embodiment of the invention, the feed device has a slide-in unit with the intermediate region, which can be removed from a connection piece arranged above it, and also and pushed onto it (for example via a corresponding guide designed to complement the connection piece and slide-in unit).

This makes it possible to use different inserts with different shapes and/or geometries, in particular with differently shaped curved walls depending on the requirements (pourability, adhesive properties of the products, type of release agent, clumping, bouncing, coarseness, etc.). It is therefore conceivable to keep an entire (format) set of different slide-in units available and to use them as required by simply inserting them in a modular manner, in particular without tools. For example, raisins as bulk materials-due to their adhesive properties-require a greater incline in every area, especially at the bottom end of the wall, than products with lower adhesive properties, in order to prevent sticking.

In a further embodiment of the invention, the product stream is only switched on by a controlled gate valve (bringer release) in the supply line once the belt is running. This can also reduce or even prevent back pressure on a conveyor system arranged below the outlet opening.

The feed device is arranged in the inspection device by means of a quick-release fastener that can be operated without tools, in such a way that lateral removal or insertion, in particular substantially in the y direction, is possible. This advantageously enables a convenient, simple and quick change without further disassembly of the inspection device.

In a further embodiment of the invention, the feed device is symmetrical to the x-z plane in order to enable insertion on both sides, in particular laterally offset insertion. In addition to simpler production, this also allows the conveying direction to be changed without major modifications.

In a particularly preferred embodiment of the invention, the feed device, for use in a corresponding inspection device, has elements that can be arranged in it or on it and are preferably modularly exchangeable, in particular which can be inserted or pushed in, such as gate valves, filter elements, sieves or baffle elements. These elements are preferably arranged in the area of the connection piece, in particular on or in the connection piece. The elements can preferably be in the form of inserts that can be pushed in and pulled out, and the elements can preferably be inserted or pushed into the inserts themselves in a modular, interchangeable manner. This makes it easy to extend the field of application of the feed device depending on the type of bulk material. The elements can be pushed in or inserted by the user or the operator themselves, and latching positions are also conceivable.

In a further embodiment of the invention, a dust extraction device is arranged on the feed device or integrated into the feed device. This dust extraction device can preferably be provided in the area of the connection piece, in particular on or in the connection piece. This can prevent contamination and impairment of the inspection outcomes and, in particular, the risk of ignitable dust/air mixtures.

In a preferred embodiment of the invention, the feed device is partially designed as a component of a radiation protection housing (of an inspection device). In particular, the curved wall arranged upstream (product stream) can simultaneously serve as the (radiation protection) housing wall of the inspection device, and assume the protective/shielding function against radiation, in particular radioactive radiation. This is a simple way of achieving a small constructed size.

In a particular embodiment, according to the method according to the invention, the feed quantity at the inlet opening and/or the height and/or inclination of the adjusting element and/or the conveying speed is adjusted or controlled in order to optimize the (X-ray) inspection outcomes. It is also conceivable to provide adjustable lateral guides, and the lateral distance of the lateral guides can be regulated accordingly either on its own or in combination with the aforementioned adjustment options. The adjustment and/or control is carried out in such a way that a substantially constant—and if desired, low—product stream height is generated and/or the radiographic width of the (X-ray) inspection device is optimally utilized and/or the highest possible throughput is achieved.

Further advantageous embodiments of the invention are shown in the dependent claims.

The invention is explained in more detail below with reference to an embodiment of the invention shown in the drawing.

In the drawing:

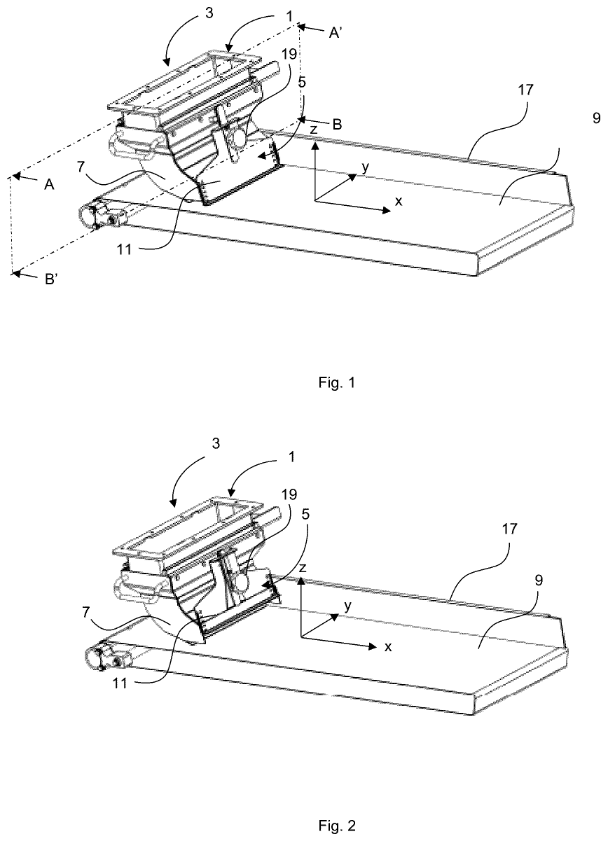

FIG. 1 shows a perspective view of a feed hopper with conveyor belt, height-adjustable, closed plate, and a handwheel;

FIG. 2 shows a perspective view of the feed hopper with conveyor belt according to FIG. 1 with open adjusting plate;

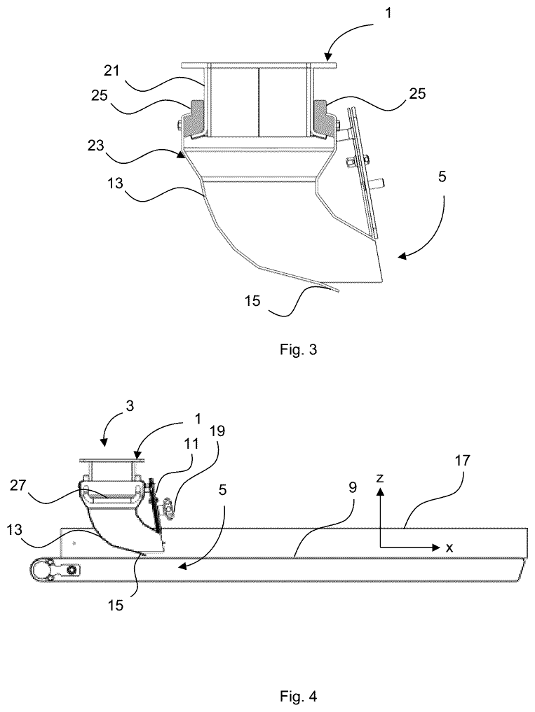

FIG. 3 shows a longitudinal section of a feed hopper according to FIG. 1 as a detail without adjusting plate and handwheel;

FIG. 4 shows a side view (longitudinal section) of the feed hopper with conveyor belt according to FIG. 2;

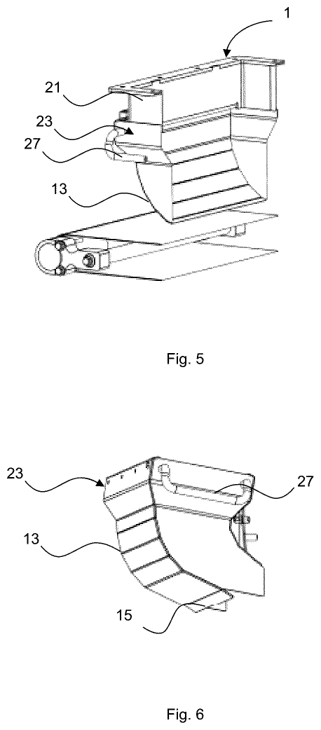

FIG. 5 shows a cross-section of a feed hopper with conveyor belt according to FIG. 1 (along the sectional plane A-A′-B-B′);

FIG. 6 shows a perspective view of a slide-in unition of the feed hopper as a detail according to FIG. 5;

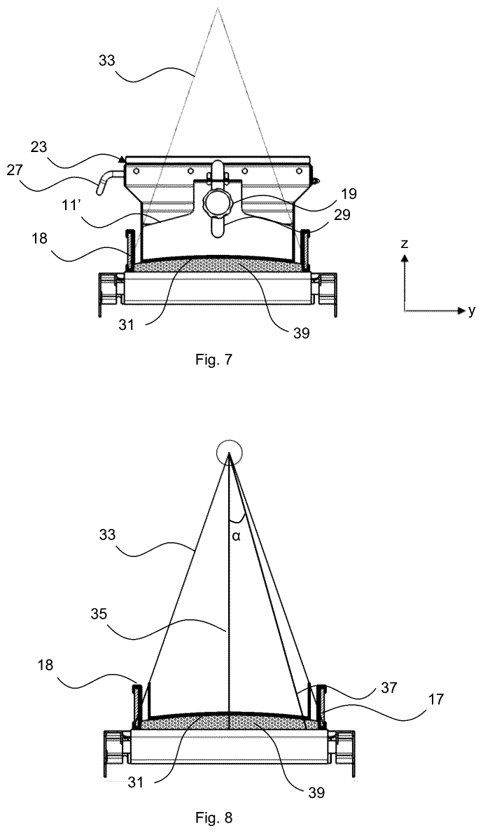

FIG. 7 shows a front view of the insertion of the feed hopper according to FIG. 6, with an adjusting plate with a curved lower edge;

FIG. 8 shows a schematic sectional view (cross-section) of a beam path; and

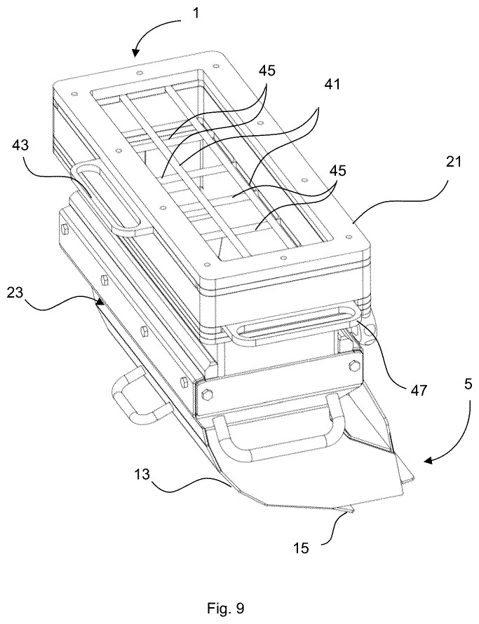

FIG. 9 shows a schematic perspective view of the feed hopper according to FIG. 3 with a slide-in unit with baffle rods.

The feed device according to the invention in the form of a feed hopper 1, shown schematically in FIG. 1, FIG. 2 and FIG. 4, has an upper inlet opening 3 and a lower outlet opening 5.

The upper inlet opening 3 substantially points in the z direction and is used to receive bulk materials such as rice, raisins, nuts or coffee beans. For reasons of clarity, the schematic diagram does not show the connection to a storage container, nor a holder for the feed device, as this is familiar to a person skilled in the art.

The lower outlet opening substantially points in the x direction/conveying direction of a conveyor belt 9, so that the bulk material is deflected from the vertical direction of fall (z direction) onto the horizontal conveyor belt (in the x-y plane).

The conveyor belt has a lateral rear guide 17 to laterally limit and guide the bulk material to be conveyed. The front lateral guide has been omitted from the drawing for reasons of clarity.

An adjusting element 11, for example in the form of a plate, is arranged to close off the lower outlet opening 5. This adjusting element can be moved in its position in the z direction and locked, for example, by means of a handwheel 19.

As can be seen from the side view of the feed hopper 1 shown in FIG. 3 and FIG. 4 (in FIG. 4 as an individual unit without conveyor belt 9 and in FIG. 3 with conveyor belt), the adjusting element 11 has an inclination to the vertical z axis and is arranged with its lower edge slightly inclined to the right when viewed in the x direction. The inclination facilitates the continuous application of the bulk material onto the conveyor belt 9, and the degree of inclination can be adjusted depending on the flowability of the bulk material.

The feed hopper 1 transitions from its upper inlet opening 3 via an intermediate region 7 into its lower outlet opening 5, and the cross-section becomes smaller in the direction of the outlet opening 5.

Viewed in the x direction or conveying direction, the intermediate region has a rear wall 13, which serves as a deflecting chute for the bulk material. The transition from the z direction almost to the x direction is achieved by a corresponding curvature of the wall 13; and this curvature does not have to be in the form of a continuous curve, but—as shown—can also be in the form of several adjoining straight plates. Preferably, the rear wall 13 does not have a tangential horizontal area at any point, so that products can be prevented from remaining in the feed hopper 1.

In its lower end area (see also FIG. 6), the wall 13 has a sloping area in the form of a lower edge 15, specifically in front of the closing adjusting element 11 and/or the outlet opening 5. This facilitates the emptying of the feed hopper and prevents the product stream of the bulk material from jamming.

In addition, the lower edge 15 of the end region of the intermediate region 7 allows the belt to be emptied before the bulk material is applied, thus preventing contamination from entering the product stream.

FIG. 4 shows the adjusting element 11 in the fully open position. In contrast to FIG. 4, FIG. 3 does not show the adjusting element 11 or the handwheel 19.

The feed hopper 1 has a connection piece 21 in its upper area, which is used for connection, for example by means of a feed pipe connected via a flange, not shown.

Connected to this connection piece is a slide-in unit 23 arranged underneath, which can preferably be pushed into the connection piece from the front in the y direction, for example via a corresponding guide 25 designed to complement the connection piece and slide-in unit.

To make it easier to push in and pull out, the slide-in unit has a handle 27 on the side (in FIG. 4 from the front) in its upper area.

As can be seen from FIG. 5, the feed hopper is symmetrical with regard to the x-z plane, so that it can also be inserted in an inverted position. This means that, if desired, the belt direction of an existing system can be changed by simply inserting the slide-in unit 23 into the connection piece 21 in the opposite direction, without the need for further modifications.

The feed hopper 1 shown in FIG. 7 is provided with an adjusting element 11′ which, in contrast to the adjusting element 11 in FIG. 1 and FIG. 2, has a curved lower edge 31 instead of a straight lower edge.

The curvature of the lower edge is symmetrical to the x-z plane, with a central raised area and flanks that increase continuously downwards at the sides. The product stream height in the y direction can be adapted to a passage path of an X-ray beam 33 through the bulk material by this curved lower edge 31.

Like the adjusting element 11, the adjusting element 11′ has a vertical slotted hole 29 so that the adjusting element 11, 11′ can be moved in the z direction and fixed in the desired position by means of the handwheel 19.

As can be seen from FIG. 8, for a typical fan-shaped X-ray beam 33, i.e., a fan-shaped beam path propagating from a point source, the central beam 35 is aligned perpendicular to the y axis, whereas the beam paths have an increasing angle α towards the sides of the belt. Accordingly, the path of the X-rays through the bulk material or the product stream (up to an X-ray detector, in particular a line scan camera) increases as a function of the distance from the center, and/or the angle α formed with the central vertical.

For example, the path of the X-rays through the product stream for the beam 37 shown in FIG. 8 no longer corresponds to the height of the product stream (at the point of impact), but corresponds to a longer path, namely the quotient of the height and the cosine of the angle α, according to the cosine formula.

Beam path=product stream height/cos α

The curvature of the lower edge and thus the height of the product stream over the belt width (y direction) can preferably be selected according to the geometry of the X-rays 33 in such a way that the radiation path or the passage path through the product stream is constant over the belt width (y-direction). Accordingly, X-rays propagating from an X-ray source in a fan shape in the y direction can be used without changing the gray values at the edges.

The embodiment of a connection piece 21 shown in FIG. 9 basically corresponds to the connection piece 21 described above, but also shows baffle rods 41 and 45 arranged in the connection piece.

The upper (preferably two) baffle rods 41 oriented in the y direction can be pushed into and pulled out of the connection piece 21 along the x direction using a handle 43 in the form of a slide-in unit. The lower (preferably four) baffle rods 45 oriented in the x direction can be pushed into and pulled out of the connection piece 21 along the y direction using a handle 47 in the form of a slide-in unit. Of course, other slide-in units with a different number and/or type of elements, such as gate valves, filter elements, strainers or baffle elements, can also be inserted. In addition, elements, in particular rods, can also be inserted or slid into the slide-in units themselves in a modular, interchangeable manner.

The baffle rods 41 and 45 can be arranged in a suitable geometry—depending on the type of bulk material 39—in order to better distribute the bulk material 39 fed from above.

For example, as shown in FIG. 9, upper baffle rods 41 can be arranged in a first upper row 2 transversely to a lower row of four lower baffle rods 45 distributed over the interior of the connection piece 41.

The arrangement of the baffle rods can be adapted to the given bulk material 39 in terms of the type of baffle rods and/or their position in order to enable optimum, preferably uniform distribution.

### LIST OF REFERENCE SYMBOLS

1 Feed hopper
3 Upper inlet opening
5 Bottom outlet opening
7 Intermediate region
9 Conveyor belt
11 Adjusting element with straight lower edge
11′ Adjusting element with curved lower edge
13 Wall
15 Lower edge at the end of the wall
17 Rear lateral guide
18 Front lateral guide
19 Handwheel
21 Connection piece
23 Slide-in unit
25 Guide
27 Handle
29 Slotted hole
31 Curved lower edge of the adjusting element
33 Fan-shaped X-rays
35 center vertical beam path
37 Beam path with angle α
39 Bulk materials
41 Upper baffle rods
43 Handle for upper baffle rods
45 Lower baffle rods
47 Handle for lower baffle rods
49 Lower baffle rods
51 Flange
x Conveying direction of the conveyor belt
y Transverse direction of the conveyor belt
Z Height direction of the feed hopper and/or the feed device
α Angle of beam path with the center line

1. A hygienic modular feed device for an inspection device, in particular an X-ray inspection device, for transferring products of a product stream consisting of bulk material, which is supplied from a substantially vertical z direction into a substantially horizontal conveying direction x, and onto a conveying plane located in the x-y direction perpendicular to the z direction, hygienic modular feed device comprising
an upper inlet opening as viewed in the z direction, oriented substantially in the z direction, and
a lower outlet opening as viewed in the z direction, oriented substantially in the x direction, both the upper inlet opening and the lower outlet opening connected to an intermediate region,
wherein the intermediate region has a curved wall on the rear side, as viewed at least in the conveying direction x, to gently change the direction of the products from the z direction into the x direction such that the pressure resulting from the falling movement of the products is at least partially absorbed by the wall, and accordingly the pressure of the product stream on a conveyor system, in particular conveyor belt, arranged below the outlet opening is reduced.

2. The hygienic modular feed device according to claim 1, wherein the curved rear wall ends in the direction of the outlet opening before it merges into the horizontal, so that each region of the curved wall has an angle tangential to the horizontal x axis greater than zero.

3. The hygienic modular feed device according to claim 1, wherein the intermediate region has a downwardly bending lower edge in its end region before the outlet opening, to allow for reliable emptying after the end of the product feed.

4. The hygienic modular feed device according to claim 1, wherein the hygienic modular feed device has an adjusting element at the outlet opening substantially adjustable in height in the z direction to vary the height of the outlet opening.

5. The hygienic modular feed device according to claim 4, wherein the adjusting element is adjustable in its inclination with respect to the vertical z axis, to enable adaptation to the pourability of the products of the bulk material.

6. The hygienic modular feed device according to claim 4, wherein the hygienic modular feed device has a control device which, during operation of the inspection device, enables the height and/or the angle of inclination of the adjusting element to be adapted to the conveying speed of the conveyor system, so as to
a) generate a continuously specifiable product stream height that is as constant as possible, and/or
b) to generate continuously specifiable mass flow that is as constant as possible, and/or
c) to optimally utilize the radiographic width of an X-ray inspection device, and/or
d) to ensure a constant single layer format for visual inspection.

7. The hygienic modular feed device according to claim 4, wherein the adjusting element has a curved lower edge, such that the passage path of the X-rays through the bulk material is almost the same length at any angle (α).

8. The hygienic modular feed device according to claim 1, wherein the hygienic modular feed device has a connection piece in the region of the inlet opening, in particular a multi-step connection piece with different predefined connection widths.

9. An inspection device having an hygienic modular feed device according to claim 1, wherein the hygienic modular feed device is arranged in the inspection device by means of a quick-release fastener actuatable without tools such that lateral removal or insertion is made possible.

10. The inspection device according to claim 9, wherein the hygienic modular feed device is symmetrical about the x-z plane to enable insertion on both sides.

11. The inspection device according to claim 9, wherein the hygienic modular feed device has elements that are one or more of: arrangeable arranged in it or on it; and are modularly exchangeable.

12. The inspection device according to claim 9, wherein a dust extraction device is provided, arranged on the hygienic modular feed device or integrated in the hygienic modular feed device.

13. The inspection device according to claim 9, wherein the hygienic modular feed device is partially a component of a radiation protection housing.

14. A method for optimizing the inspection outcomes of an inspection device, in particular an X-ray inspection device having a feed device according to claim 1, wherein one or more of
the supply quantity at the inlet opening,
the height and/or inclination of the adjusting element, and
the conveying speed of a conveyor device
is controllable such that one or more of: a substantially constant product stream height is generated; the radiographic width of an X-ray inspection device is optimally utilized; and the highest possible throughput is achieved.
